(19) United States
(12) Patent Application Publication
(10) Pub. No.: US 2025/0148956 A1
(43) Pub. Date: May 8, 2025

(54) DISPLAY APPARATUS AND METHOD OF GAMMA CONTROL USING THE SAME

(71) Applicant: Samsung Display Co., LTD., Yongin-si (KR)

(72) Inventors: JINHYEOK HUH, Yongin-si (KR); JU-BONG AN, Yongin-si (KR)

(21) Appl. No.: 18/928,400

(22) Filed: Oct. 28, 2024

(30) Foreign Application Priority Data
Nov. 7, 2023 (KR) 10-2023-0153144

(51) Int. Cl. G09G 3/20; G09G 5/10

(52) U.S. Cl. CPC G09G 3/2092; G09G 5/10; G09G 2320/0233; G09G 2320/0276; G09G 2320/0626; G09G 2320/0673

(57) ABSTRACT

A display apparatus includes a display panel and a display panel driver. The display panel driver drives the display panel. The display panel driver determines a target luminance for a target luminance setting value and a target grayscale value based on a first luminance for a first adjacent luminance setting value and a first grayscale value and a second luminance for a second adjacent luminance setting value and a second grayscale value. At least one selected from the first grayscale value and the second grayscale value is different from the target grayscale value.

This application claims priority to Korean Patent Application No. 10-2023-0153144, filed on Nov. 7, 2023, and all the benefits accruing therefrom under 35 U.S.C. § 119, the content of which in its entirety is herein incorporated by reference.

### BACKGROUND

### 1. Field

Embodiments of the invention relate to a display apparatus and a method of gamma control using the display apparatus. More particularly, embodiments of the invention relate to a display apparatus with reduced luminance change amount when a luminance setting value is changed and a method of gamma control using the display apparatus.

### 2. Description of the Related Art

Generally, a display apparatus includes a display panel and a display panel driver. The display panel displays an image based on input image data. The display panel typically includes a plurality of gate lines, a plurality of data lines and a plurality of pixels. The display panel driver may include a gate driver, a data driver, a gamma reference voltage generator and a driving controller. The gate driver outputs gate signals to the gate lines. The data driver outputs data voltages to the data lines. The gamma reference voltage generator outputs a gamma reference voltage to the data driver. The driving controller controls an operation of the gate driver, an operation of the data driver and an operation of the gamma reference voltage generator. The driving controller may output a reference luminance to the gamma reference voltage generator based on a luminance setting value.

### SUMMARY

In a display apparatus, the driving controller may not store reference luminance voltages for all luminance setting values, but may store only reference luminances for measured luminance setting values. The driving controller may generate a reference luminance for a luminance setting value between the measured luminance setting values by an interpolation method.

If the reference setting value is not properly generated in the interpolation method, a luminance change amount may be great when a luminance setting value is changed. If the luminance change amount is great, the luminance change may be shown to a user so that a display quality may be deteriorated.

Embodiments of the invention provide a display apparatus capable of reducing a luminance change amount when a luminance setting value is changed.

Embodiments of the invention also provide a method of gamma control using the display apparatus.

In an embodiment of a display apparatus according to the invention, the display apparatus includes a display panel and a display panel driver. In such an embodiment, the display panel driver drives the display panel, and the display panel driver determines a target luminance for a target luminance setting value and a target grayscale value based on a first luminance for a first adjacent luminance setting value and a first grayscale value and a second luminance for a second adjacent luminance setting value and a second grayscale value. In such an embodiment, at least one selected from the first grayscale value and the second grayscale value is different from the target grayscale value.

In an embodiment, the first adjacent luminance setting value may be less than the target luminance setting value, and the first grayscale value may be equal to or greater than the target grayscale value.

In an embodiment, the first grayscale value may be greater than the target grayscale value.

In an embodiment, the first grayscale value may be greater than the target grayscale value by one.

In an embodiment, the second adjacent luminance setting value may be greater than the target luminance setting value, and the second grayscale value may be equal to or less than the target grayscale value.

In an embodiment, the second grayscale value may be less than the target grayscale value.

In an embodiment, the second grayscale value may be less than the target grayscale value by one.

In an embodiment, the display panel driver may determine a plurality of target luminances for a plurality of target grayscale values based on a plurality of luminances in the first adjacent luminance setting value and a plurality of luminances in the second adjacent luminance setting value.

In an embodiment, the display panel driver may determine an interpolation luminance for an interpolation grayscale value between the target grayscale values using adjacent target luminances of adjacent target grayscale values adjacent to the interpolation grayscale value in the target luminance setting value. In such an embodiment, the adjacent target luminances may be luminances in the target luminance setting value.

In an embodiment, the display panel driver may determine an interpolation luminance for an interpolation grayscale value between the target grayscale values in the target luminance setting value based on a luminance in the first adjacent luminance setting value and a luminance in the second adjacent luminance setting value.

In an embodiment, the display panel driver may include a gamma controller, a gamma reference voltage generator and a data driver. In such an embodiment, the gamma controller may determine the target luminance for the target luminance setting value and the target grayscale value, the gamma reference voltage generator may generate a gamma reference voltage based on a reference luminance including the target luminance, and the data driver may generate a data voltage based on a grayscale value of input image data and the gamma reference voltage and output the data voltage to the display panel.

In an embodiment, the display panel driver may include a power controller, a gamma controller, a gamma reference voltage generator and a data driver. In such an embodiment, the power controller may receive an input luminance setting value and an input grayscale value and output an output luminance setting value and an output grayscale value, the gamma controller may determine the target luminance for the target luminance setting value and the target grayscale value, the gamma reference voltage generator may generate a gamma reference voltage based on a reference luminance including the target luminance, and the data driver may generate a data voltage based on the output grayscale value and the gamma reference voltage and output the data voltage to the display panel.

In an embodiment, the output luminance setting value may be less than the input luminance setting value, and the output grayscale value may be greater than the input grayscale value.

In an embodiment of a method of gamma control for a display apparatus according to the invention, the method includes determining a target luminance for a target luminance setting value and a target grayscale value based on a first luminance for a first adjacent luminance setting value and a first grayscale value and a second luminance for a second adjacent luminance setting value and a second grayscale value, where at least one selected from the first grayscale value and the second grayscale value is different from the target grayscale value.

In an embodiment, the first adjacent luminance setting value may be less than the target luminance setting value, and the first grayscale value may be greater than the target grayscale value.

In an embodiment, the second adjacent luminance setting value may be greater than the target luminance setting value, and the second grayscale value may be less than the target grayscale value.

In an embodiment, a display panel driver of the display apparatus may determine a plurality of target luminances for a plurality of target grayscale values based on a plurality of luminances in the first adjacent luminance setting value and a plurality of luminances in the second adjacent luminance setting value.

In an embodiment, the display panel driver may determine an interpolation luminance for an interpolation grayscale value between the target grayscale values using adjacent target luminances of adjacent target grayscale values adjacent to the interpolation grayscale value in the target luminance setting value, and the adjacent target luminances may be luminances in the target luminance setting value.

In an embodiment, the display panel driver may determine an interpolation luminance for an interpolation grayscale value between the target grayscale values in the target luminance setting value based on a luminance in the first adjacent luminance setting value and a luminance in the second adjacent luminance setting value.

According to embodiments of the display apparatus and the method of gamma control using the display apparatus, the target luminance for the target luminance setting value and the target grayscale value may be determined based not on the luminance of the same grayscale value for the adjacent measured luminance setting value but on the closest luminance for the adjacent measured luminance setting value when determining the target luminance.

Thus, in such embodiments, when the luminance setting value is changed, the luminance change amount may be reduced so that the display quality of the display panel may be enhanced.

### BRIEF DESCRIPTION OF THE DRAWINGS

The above and other features of the invention will become more apparent by describing in detailed embodiments thereof with reference to the accompanying drawings, in which:

FIG. 1 is a block diagram illustrating a display apparatus according to an embodiment of the invention;

FIG. 2 is a block diagram illustrating a driving controller of FIG. 1;

FIG. 3 is a graph illustrating luminances according to grayscale values when a luminance setting value is 4 nit;

FIG. 4 is a graph illustrating luminances according to grayscale values when the luminance setting value is 10 nit;

FIG. 5 is a graph illustrating luminances according to grayscale values when the luminance setting value is 7 nit;

FIG. 6 is a graph illustrating a luminance error according to luminance setting values for a grayscale value of 15 and a grayscale value of 31;

FIG. 7 is a table illustrating a method of gamma control according to a comparative embodiment;

FIG. 8 is a table illustrating an embodiment of a method of gamma control of a gamma controller of FIG. 2;

FIG. 9 is a graph illustrating luminances according to luminance setting values of a comparative embodiment and the embodiment for a luminance of 0.01 nit;

FIG. 10 is a graph illustrating luminances according to luminance setting values of a comparative embodiment and the embodiment for a luminance of 0.05 nit;

FIG. 11 is a graph illustrating luminances according to luminance setting values of a comparative embodiment and the embodiment for a luminance of 0.1 nit;

FIG. 12 is a graph illustrating luminance errors according to luminance setting values of the comparative embodiment and the embodiment for the luminance of 0.01 nit;

FIG. 13 is a graph illustrating luminance errors according to luminance setting values of the comparative embodiment and the embodiment for the luminance of 0.05 nit;

FIG. 14 is a graph illustrating luminance errors according to luminance setting values of the comparative embodiment and the embodiment for the luminance of 0.1 nit;

FIG. 15 is a table illustrating a method of gamma control of a gamma controller of a display apparatus according to an embodiment of the invention;

FIG. 16 is a table illustrating a method of gamma control of a gamma controller of a display apparatus according to an embodiment of the invention;

FIG. 17 is a block diagram illustrating a driving controller of a display apparatus according to an embodiment of the invention;

FIG. 18 is a table illustrating an operation of a power controller of FIG. 17;

FIG. 19 is a graph illustrating an operation of the power controller of FIG. 17;

FIG. 20 is a block diagram illustrating an electronic apparatus according to an embodiment of the invention; and

FIG. 21 is a diagram illustrating an embodiment in which the electronic apparatus of FIG. 20 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

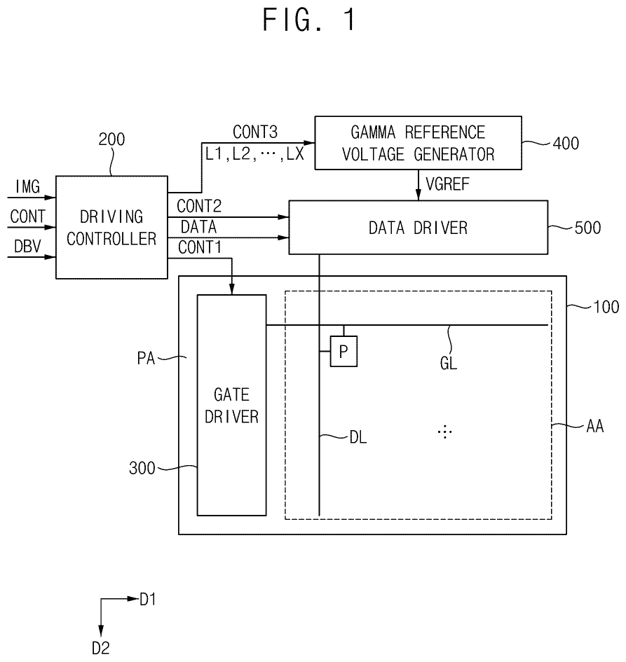

FIG. 1 is a block diagram illustrating a display apparatus according to an embodiment of the invention.

Referring to FIG. 1, an embodiment of the display apparatus includes a display panel 100 and a display panel driver. The display panel driver drives the display panel 100. The display panel driver may include a driving controller 200, a gate driver 300, a gamma reference voltage generator 400 and a data driver 500.

In an embodiment, for example, the driving controller 200 and the data driver 500 may be integrally formed as a single unit (e.g., module or chip). In an embodiment, for example, the driving controller 200, the gamma reference voltage generator 400 and the data driver 500 may be integrally formed as a single unit. A driving module including at least the driving controller 200 and the data driver 500 which are integrally formed therein may be called to a timing controller embedded data driver (TED).

The display panel 100 may have a display region AA on which an image is displayed and a peripheral region PA adjacent to the display region AA.

The display panel 100 may include a plurality of gate lines GL, a plurality of data lines DL and a plurality of pixels P connected to the gate lines GL and the data lines DL. The gate lines GL may extend in a first direction D1 and the data lines DL may extend in a second direction D2 crossing the first direction D1.

The driving controller 200 receives input image data IMG and an input control signal CONT from an external apparatus (e.g., an application processor). In an embodiment, for example, the input image data IMG may include red image data, green image data and blue image data. In an embodiment, for example, the input image data IMG may include white image data. In an embodiment, for example, the input image data IMG may include magenta image data, yellow image data and cyan image data. The input control signal CONT may include a master clock signal and a data enable signal. The input control signal CONT may further include a vertical synchronizing signal and a horizontal synchronizing signal. The driving controller 200 may further receive a luminance setting value DBV from the external apparatus. Alternatively, the luminance setting value DBV may be determined in the driving controller 200.

The driving controller 200 generates a first control signal CONT1, a second control signal CONT2, a third control signal CONT3, a reference luminance L1, L2, . . . , LX and a data signal DATA based on the input image data IMG, the input control signal CONT and the luminance setting value DBV.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500. The driving controller 200 may generate the data signal DATA based on the input image data IMG and the luminance setting value DBV.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 may generate the reference luminance L1, L2, . . . , LX based on the luminance setting value DBV and may output the reference luminance L1, L2, . . . , LX to the gamma reference voltage generator 400. Alternatively, the driving controller 200 may generate the reference luminance L1, L2, . . . , LX based on the luminance setting value DBV and an input grayscale value of the input image data IMG and may output the reference luminance L1, L2, . . . , LX to the gamma reference voltage generator 400.

The gate driver 300 generates gate signals driving the gate lines GL in response to the first control signal CONT1 received from the driving controller 200. The gate driver 300 outputs the gate signals to the gate lines GL. In an embodiment, for example, the gate driver 300 may sequentially output the gate signals to the gate lines GL. In an embodiment, for example, the gate driver 300 may be mounted on the peripheral region PA of the display panel 100. In an embodiment, for example, the gate driver 300 may be integrated on the peripheral region PA of the display panel 100.

The gamma reference voltage generator 400 generates a gamma reference voltage VGREF based on the third control signal CONT3 and the reference luminance L1, L2, . . . , LX received from the driving controller 200. The gamma reference voltage generator 400 provides the gamma reference voltage VGREF to the data driver 500.

In an embodiment, for example, the reference luminance L1, L2, . . . , LX may be luminances for predetermined reference grayscale values of the gamma reference voltage VGREF. In the gamma reference voltage generator 400, the gamma reference voltages VGREF for the predetermined reference grayscale values may be generated based on the reference luminances L1, L2, . . . , LX. In the gamma reference voltage generator 400, the gamma reference voltages VGREF for grayscale values between the predetermined reference grayscale values may be generated by interpolation based on the reference luminances L1, L2, . . . , LX.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

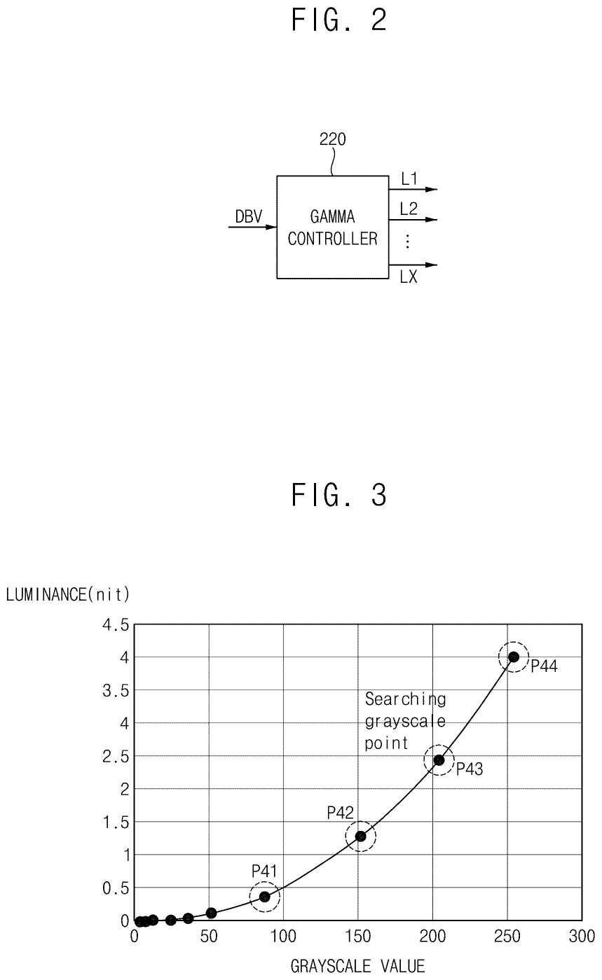

FIG. 2 is a block diagram illustrating the driving controller 200 of FIG. 1.

Referring to FIGS. 1 and 2, the display panel drier may include the driving controller 200. In an embodiment, the driving controller 200 may include a gamma controller 220.

The display panel driver (e.g., the gamma controller 220) may generate the reference luminance L1, L2, . . . , LX corresponding to the luminance setting value DBV.

The luminance setting value DBV may mean a luminance for a maximum grayscale value. In an embodiment, for example, when the luminance setting value DBV is 4 nit, an output luminance of the maximum grayscale value (e.g., a grayscale value of 255) may be 4 nit in the luminance setting value DBV of 4 nit. In an embodiment, for example, when the luminance setting value DBV is 7 nit, an output luminance of the maximum grayscale value (e.g., a grayscale value of 255) may be 7 nit in the luminance setting value DBV of 7 nit. In an embodiment, for example, when the luminance setting value DBV is 10 nit, an output luminance of the maximum grayscale value (e.g., a grayscale value of 255) may be 10 nit in the luminance setting value DBV of 10 nit.

The luminances for some of the luminance setting values DBV may be set by measurement. The setting process of the luminances for some of the luminance setting values DBV by the measurement may be referred to as multi time programming (“MTP”).

Luminances for luminance setting values DBV in which the measurement is not performed may be determined by interpolation using the luminances for the luminance setting values DBV in which the measurement is performed.

In addition, the measurement may not be performed for all grayscale values for the luminance setting value DBV in which the measurement is performed so that the luminance may be set only for some grayscale values by measurement. Luminances for the grayscale values in which the measurement is not performed may be determined by interpolation using the luminances for the grayscale values in which the measurement is performed for the luminance setting value DBV in which the measurement is performed.

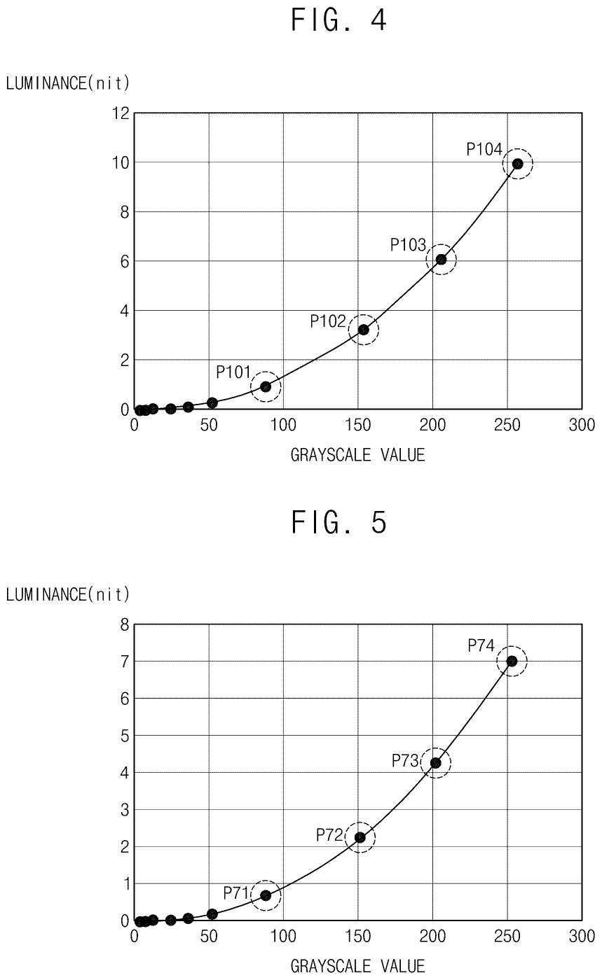

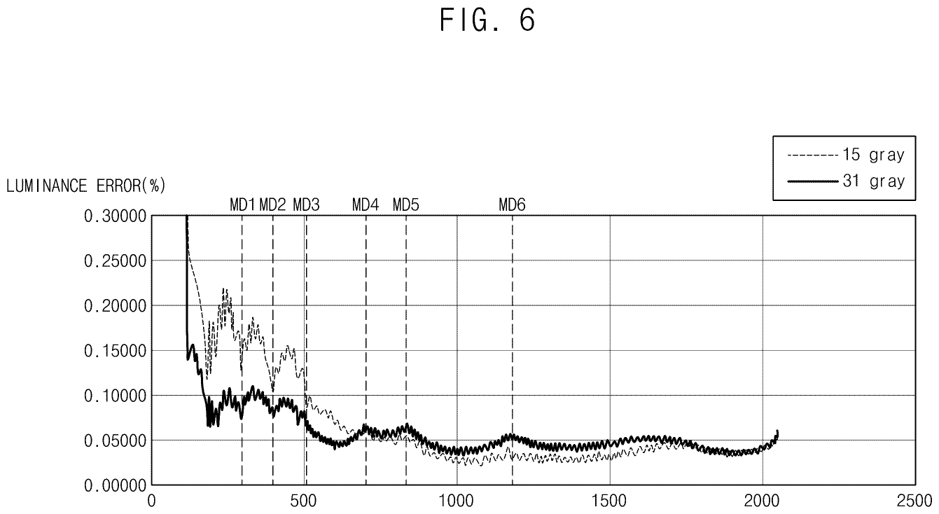

FIG. 3 is a graph illustrating luminances according to grayscale values (i.e., luminances versus grayscale values) when the luminance setting value DBV is 4 nit. FIG. 4 is a graph illustrating luminances according to grayscale values when the luminance setting value DBV is 10 nit. FIG. 5 is a graph illustrating luminances according to grayscale values when the luminance setting value DBV is 7 nit. FIG. 6 is a graph illustrating a luminance error according to luminance setting values DBV for a grayscale value of 15 and a grayscale value of 31.

FIGS. 3 to 6 illustrate a method of gamma control according to a comparative embodiment. In the method of gamma control according to the comparative embodiment, a target luminance for a target luminance setting value and a target grayscale value may be determined based on a first luminance for a first adjacent luminance setting value and the target grayscale value and a second luminance for a second adjacent luminance setting value and the target grayscale value.

When determining the target luminance for the target luminance setting value in which the measurement is not performed, the target luminance may be determined based on the luminance of the same grayscale value for the adjacent measured luminance setting value.

FIG. 3 illustrates a case in which the luminance setting value DBV is 4 nit. Thus, the luminance for the grayscale value of 255 may be 4 nit. For example, the luminance setting value DBV of 4 nit may be the luminance setting value DBV in which the measurement is performed.

Dots (Searching grayscale point) in FIG. 3 represent luminances for grayscale values in which the measurement is performed in the luminance setting value DBV of 4 nit. In FIG. 3, the number of the searching grayscale points is ten. For example, ten luminances are measured for ten grayscale values in the luminance setting value DBV of 4 nit and the reference luminances L1, L2, . . . , LX may be determined such that the ten luminances have proper gamma values. Luminances may be properly determined for the grayscale values in which the measurement is not performed in the luminance setting value DBV of 4 nit using the above ten measured luminances. In FIG. 3, four measured luminances for four measuring grayscale values of the ten measuring grayscale values are represented as P41, P42, P43 and P44.

FIG. 4 illustrates a case in which the luminance setting value DBV is 10 nit. Thus, the luminance for the grayscale value of 255 may be 10 nit. For example, the luminance setting value DBV of 10 nit may be the luminance setting value DBV in which the measurement is performed.

Dots in FIG. 4 represent luminances for grayscale values in which the measurement is performed in the luminance setting value DBV of 10 nit. In FIG. 4, the number of the dots (searching grayscale points) is ten. For example, ten luminances are measured for ten grayscale values in the luminance setting value DBV of 10 nit and the reference luminances L1, L2, . . . . LX may be determined such that the ten luminances have proper gamma values. Luminances may be properly determined for the grayscale values in which the measurement is not performed in the luminance setting value DBV of 10 nit using the above ten measured luminances. In FIG. 4, four measured luminances for four measuring grayscale values of the ten measuring grayscale values are represented as P101, P102, P103 and P104.

FIG. 5 illustrates a case in which the luminance setting value DBV is 7 nit. Thus, the luminance for the grayscale value of 255 may be 7 nit. For example, the luminance setting value DBV of 7 nit may be the luminance setting value DBV in which the measurement is not performed. The luminances for the luminance setting value DBV of 7 nit in FIG. 5 may be generated by interpolation between the luminances for the luminance setting value DBV of 4 nit in FIG. 3 and the luminances for the luminance setting value DBV of 10 nit in FIG. 4.

Ten dots in FIG. 5 may be generated by interpolation between the ten dots in FIG. 3 and the ten dots in FIG. 4. For example, the luminance of P71 in FIG. 5 may be generated by interpolation between the measured luminance of P41 in FIG. 3 and the measured luminance of P101 in FIG. 4. For example, the luminance of P72 in FIG. 5 may be generated by interpolation between the measured luminance of P42 in FIG. 3 and the measured luminance of P102 in FIG. 4. For example, the luminance of P73 in FIG. 5 may be generated by interpolation between the measured luminance of P43 in FIG. 3 and the measured luminance of P103 in FIG. 4. For example, the luminance of P74 in FIG. 5 may be generated by interpolation between the measured luminance of P44 in FIG. 3 and the measured luminance of P104 in FIG. 4.

In FIG. 6, the luminance setting values in which the measurement is performed are represented as MD1, MD2, MD3, MD4, MD5 and MD6. A horizontal axis in FIG. 6 means a DBV CODE which is proportional to the luminance setting value DBV.

As shown in a graph of FIG. 6 for a grayscale value of 15, a luminance error may be relatively little for the luminance setting values MD1, MD2, MD3, MD4, MD5 and MD6 in which the measurement is performed. In the graph of FIG. 6 for the grayscale value of 15, a luminance error may be relatively great for the luminance setting values in which the measurement is not performed (in which the luminances are generated by interpolation).

Similarly, as shown in a graph of FIG. 6 for a grayscale value of 31, a luminance error may be relatively little for the luminance setting values MD1, MD2, MD3, MD4, MD5 and MD6 in which the measurement is performed. In the graph of FIG. 6 for the grayscale value of 31, a luminance error may be relatively great for the luminance setting values in which the measurement is not performed (in which the luminances are generated by interpolation).

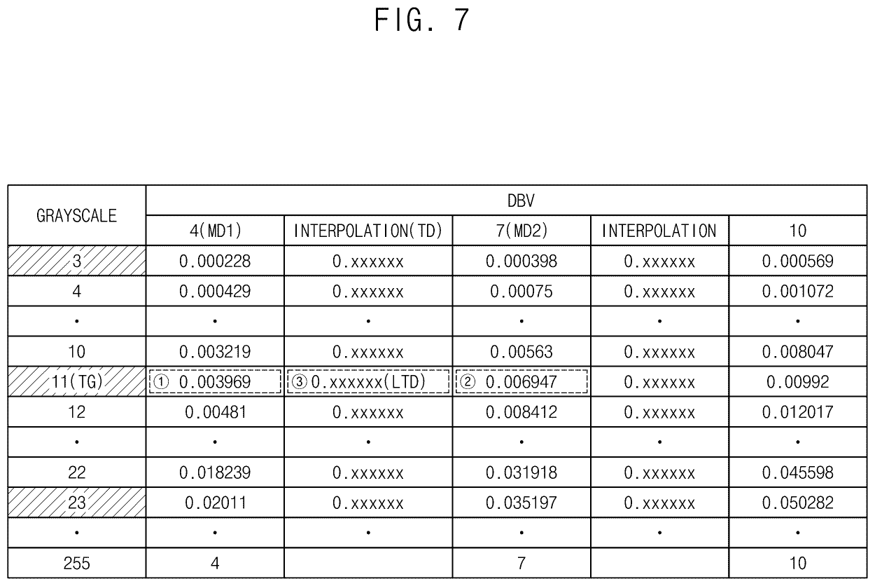

FIG. 7 is a table illustrating a method of gamma control according to the comparative embodiment. The method of gamma control according to the comparative embodiment is explained in detail referring to FIG. 7.

Referring to FIG. 7, the display panel driver (a gamma controller) determines a target luminance LTD for a target luminance setting value TD (e.g. 5 nit or 6 nit) and a target grayscale value TG (e.g. a grayscale value of 11) based on a first luminance (0.003969) for a first adjacent luminance setting value MD1 (e.g. 4 nit) and the target grayscale value TG (e.g. the grayscale value of 11) and a second luminance (0.006947) for a second adjacent luminance setting value MD2 (e.g. 7 nit) and the target grayscale value TG (e.g. the grayscale value of 11).

In the comparative embodiment, the target luminance LTD for the target luminance setting value TD (e.g., 5 nit or 6 nit) and the target grayscale value TG (the grayscale value of 11) is determined using the luminances (0.003969 and 0.006947) of the same grayscale value (the grayscale value of 11) for the adjacent measured luminance setting values (4 nit and 7 nit).

The luminance for the grayscale value of 255 is 4 nit in the first adjacent luminance setting value MD1 (4 nit) and the luminance for the grayscale value of 255 is 7 nit in the second adjacent luminance setting value MD2 (7 nit) so that correlation between the luminance representing the grayscale value of 11 in the first adjacent luminance setting value MD1 (4 nit) and the luminance representing the grayscale value of 11 in the second adjacent luminance setting value MD2 (7 nit) is not quite great and a location of the luminance in a gamma curve representing the grayscale value of 11 in the first adjacent luminance setting value MD1 (4 nit) and a location of the luminance in a gamma curve representing the grayscale value of 11 in the second adjacent luminance setting value MD2 (7 nit) are also different from each other.

However, in the comparative embodiment, the target luminance LTD for the target luminance setting value TD (e.g. 5 nit or 6 nit) and the target grayscale value TG (the grayscale value of 11) is determined using the luminances (0.003969 and 0.006947) of the same grayscale value (the grayscale value of 11) for the adjacent measured luminance setting values (4 nit and 7 nit) so that an accuracy of the interpolation is reduced and accordingly, the luminance error in the luminance setting value DBV in which the luminances are generated by interpolation is great.

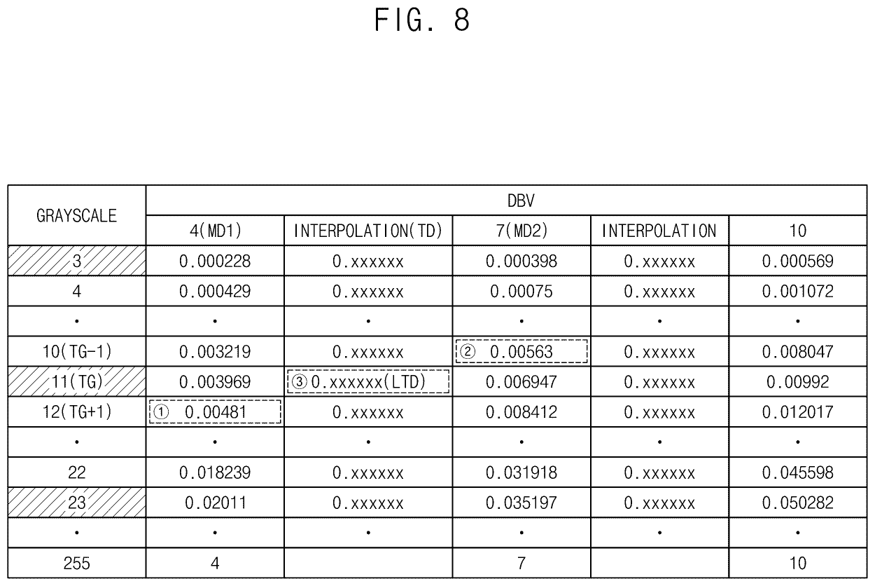

FIG. 8 is a table illustrating an embodiment of a method of gamma control of a gamma controller of FIG. 2. The method of gamma control according to an embodiment will be described in detail referring to FIG. 8.

Referring to FIGS. 1, 2 and 8, in an embodiment, the display panel driver (the gamma controller 220) determines a target luminance LTD for a target luminance setting value TD (e.g. 5 nit or 6 nit) and a target grayscale value TG (e.g. a grayscale value of 11) based on a first luminance (0.00481) for a first adjacent luminance setting value MD1 (e.g. 4 nit) and a first grayscale value (e.g. TG+1, a grayscale value of 12) and a second luminance (0.00563) for a second adjacent luminance setting value MD2 (e.g. 7 nit) and a second grayscale value (e.g. TG−1, a grayscale value of 10).

In such an embodiment, the target luminance LTD for the target luminance setting value TD (e.g. 5 nit or 6 nit) and the target grayscale value TG (the grayscale value of 11) is determined using the luminances (0.00481 and 0.00563) of the first grayscale value (the grayscale value of 12) and the second grayscale value (the grayscale value of 10) for the adjacent measured luminance setting values (4 nit and 7 nit) which are closest to a proper luminance (herein, it is assumed to 0.005) instead of using the luminances (0.003969 and 0.006947) of the same grayscale value (the grayscale value of 11) for the adjacent measured luminance setting values (4 nit and 7 nit). In the comparative embodiment shown in FIG. 7, the interpolation is performed based on the same grayscale value. In an embodiment of the invention, the interpolation is performed based on substantially the same luminance (the luminance closest to the proper luminance). The proper luminance may be predetermined in the target luminance setting value TD.

The luminance for the grayscale value of 255 is 4 nit in the first adjacent luminance setting value MD1 (4 nit) and the luminance for the grayscale value of 255 is 7 nit in the second adjacent luminance setting value MD2 (7 nit) so that correlation between the luminance representing the grayscale value of 11 in the first adjacent luminance setting value MD1 (4 nit) and the luminance representing the grayscale value of 11 in the second adjacent luminance setting value MD2 (7 nit) is not quite great and a location of the luminance in a gamma curve representing the grayscale value of 11 in the first adjacent luminance setting value MD1 (4 nit) and a location of the luminance in a gamma curve representing the grayscale value of 11 in the second adjacent luminance setting value MD2 (7 nit) are also different from each other.

Thus, in such an embodiment, the target luminance LTD for the target luminance setting value TD (e.g. 5 nit or 6 nit) and the target grayscale value TG (the grayscale value of 11) is determined using the luminances (0.00481 and 0.00563) of the first grayscale value (the grayscale value of 12) and the second grayscale value (the grayscale value of 10) for the adjacent measured luminance setting values (4 nit and 7 nit) which are closest to the proper luminance instead of using the luminances (0.003969 and 0.006947) of the same grayscale value (the grayscale value of 11) for the adjacent measured luminance setting values (4 nit and 7 nit) so that an accuracy of the interpolation may be enhanced.

In the comparative embodiment, the same grayscale value TG of the first adjacent luminance setting value MD1 may be referred to generate the target luminance LTD of the target grayscale value TG for the target luminance setting value TD.

In an embodiment of the invention, at least one selected from the first grayscale value TG+1 and the second grayscale value TG−1 which are referred to generate the target luminance LTD of the target grayscale value TG for the target luminance setting value TD may be different from the target grayscale value TG.

The first adjacent luminance setting value MD1 may be less than the target luminance setting value TD. Herein, the first grayscale value TG+1 may be equal to or greater than the target grayscale value TG. In an embodiment, for example, the first grayscale value TG+1 may be greater than the target grayscale value TG. In an embodiment, for example, the first grayscale value TG+1 may be greater than the target grayscale value TG by one. In an embodiment, as shown in FIG. 8, the first grayscale value TG+1 is greater than the target grayscale value TG by one.

In addition, the second adjacent luminance setting value MD2 may be greater than the target luminance setting value TD. Herein, the second grayscale value TG−1 may be equal to or less than the target grayscale value TG. In an embodiment, for example, the second grayscale value TG−1 may be less than the target grayscale value TG. In an embodiment, for example, the second grayscale value TG−1 may be less than the target grayscale value TG by one. In an embodiment, as shown in FIG. 8, the second grayscale value TG−1 is less than the target grayscale value TG by one.

FIG. 8 exemplifies a case in which the display panel driver (the gamma controller 220) determines one target luminance LTD for one target grayscale value TG.

In the same way, the display panel driver (the gamma controller 220) may determine plural target luminances for plural target grayscale values (e.g., grayscale values of 3, 11 and 23) based on plural luminances in the first adjacent luminance setting value and plural luminances in the second adjacent luminance setting value.

In an embodiment, for example, the display panel driver (the gamma controller 220) may determine an interpolation luminance for an interpolation grayscale value between the target grayscale values (e.g., grayscale values of 3, 11 and 23) using adjacent target luminances of adjacent target grayscale values adjacent to the interpolation grayscale value in the target luminance setting value TD. The adjacent target luminances may be luminances in the target luminance setting value.

Alternatively, the interpolation luminance for the interpolation grayscale value between the target grayscale values (e.g., grayscale values of 3, 11 and 23) in the target luminance setting value TD may be determined based on the luminance in the first adjacent luminance setting value MD1 and the luminance in the second adjacent luminance setting value MD2.

In an embodiment, the gamma controller 220 may determine the target luminance LTD for the target luminance setting value TD and the target grayscale value TG. The gamma reference voltage generator 400 may generate the gamma reference voltage VGREF based on the reference luminance L1, L2, . . . , LX including the target luminance LTD. The data driver 500 may generate the data voltage based on the grayscale value of the input image data IMG and the gamma reference voltage VGREF and output the data voltage to the display panel 100.

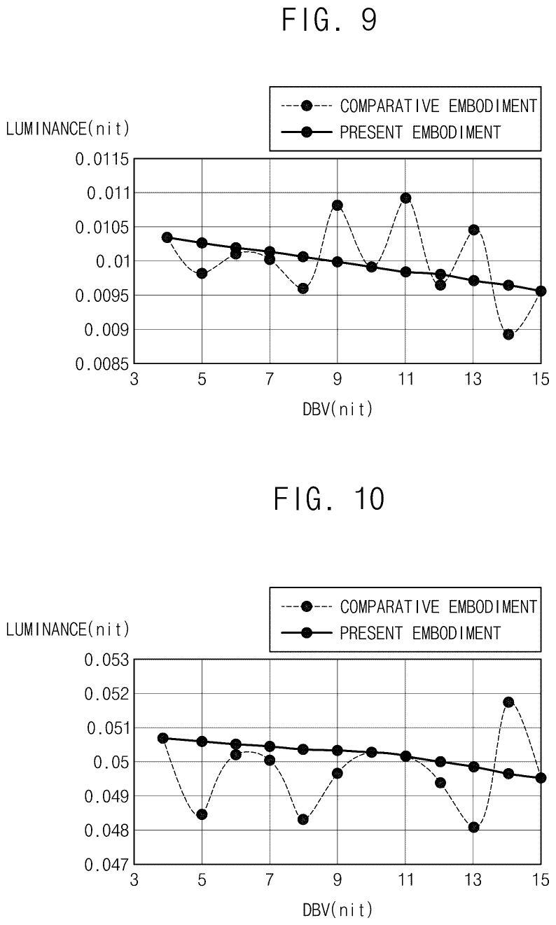

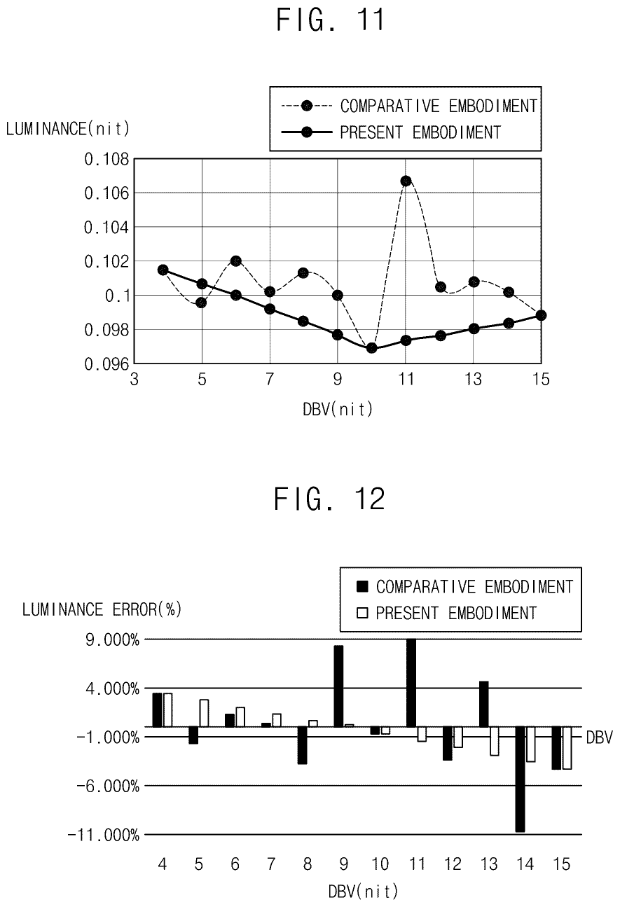

FIG. 9 is a graph illustrating luminances according to luminance setting values of a comparative embodiment and the embodiment for a luminance of 0.01 nit. FIG. 10 is a graph illustrating luminances according to luminance setting values of a comparative embodiment and the embodiment for a luminance of 0.05 nit. FIG. 11 is a graph illustrating luminances according to luminance setting values of a comparative embodiment and the embodiment for a luminance of 0.1 nit.

In FIGS. 9 to 11, the luminance setting value DBV in which the measurement (MTP) is performed may be 4 nit, 10 nit and 15 nit. In FIGS. 9 to 11, the luminances of the comparative embodiment and the luminances of an embodiment may be the same for the luminance setting values DBV of 4 nit, 10 nit and 15 nit.

FIG. 9 illustrates a case in which the display panel 100 uniformly outputs 0.01 nit even though the luminance setting value DBV is changed. In other words, the most ideal case is that a graph of the luminance shows a horizontal line corresponding to a uniform luminance (e.g., the luminance of 0.01).

In the comparative embodiment in FIG. 9, the interpolation is performed based on the same grayscale value so that the luminances for the luminance setting value DBV of 4 nit, 10 nit and 15 nit in which the measurement (MTP) is performed may be relatively stable but the luminances for the luminance setting value DBV in which the measurement (MTP) is not performed may have a great luminance deviation. In this case, a luminance change may be great according to the change of the luminance setting value DBV and the luminance change may be shown to a user so that a display quality may be deteriorated.

In an embodiment in FIG. 9, the interpolation is performed based on the same luminance instead of the same grayscale value so that the luminances for the luminance setting value DBV in which the measurement (MTP) is not performed may be stable as well as the luminances for the luminance setting value DBV of 4 nit, 10 nit and 15 nit in which the measurement (MTP) is performed. In addition, a luminance change may not be great according to the change of the luminance setting value DBV so that the luminance change may not be shown to the user.

FIG. 10 illustrates a case in which the display panel 100 uniformly outputs 0.05 nit even though the luminance setting value DBV is changed. In other words, the most ideal case is that a graph of the luminance shows a horizontal line corresponding to a uniform luminance (e.g., the luminance of 0.05).

In the comparative embodiment in FIG. 10, the interpolation is performed based on the same grayscale value so that the luminances for the luminance setting value DBV of 4 nit, 10 nit and 15 nit in which the measurement (MTP) is performed may be relatively stable but the luminances for the luminance setting value DBV in which the measurement (MTP) is not performed may have a great luminance deviation. In this case, a luminance change may be great according to the change of the luminance setting value DBV and the luminance change may be shown to the user so that a display quality may be deteriorated.

In an embodiment in FIG. 10, the interpolation is performed based on the same luminance instead of the same grayscale value so that the luminances for the luminance setting value DBV in which the measurement (MTP) is not performed may be stable as well as the luminances for the luminance setting value DBV of 4 nit, 10 nit and 15 nit in which the measurement (MTP) is performed. In addition, a luminance change may not be great according to the change of the luminance setting value DBV so that the luminance change may not be shown to the user.

FIG. 11 illustrates a case in which the display panel 100 uniformly outputs 0.1 nit even though the luminance setting value DBV is changed. In other words, the most ideal case is that a graph of the luminance shows a horizontal line corresponding to a uniform luminance (e.g., the luminance of 0.1).

In the comparative embodiment in FIG. 11, the interpolation is performed based on the same grayscale value so that the luminances for the luminance setting value DBV of 4 nit, 10 nit and 15 nit in which the measurement (MTP) is performed may be relatively stable but the luminances for the luminance setting value DBV in which the measurement (MTP) is not performed may have a great luminance deviation. In this case, a luminance change may be great according to the change of the luminance setting value DBV and the luminance change may be shown to the user so that a display quality may be deteriorated.

In an embodiment in FIG. 11, the interpolation is performed based on the same luminance instead of the same grayscale value so that the luminances for the luminance setting value DBV in which the measurement (MTP) is not performed may be stable as well as the luminances for the luminance setting value DBV of 4 nit, 10 nit and 15 nit in which the measurement (MTP) is performed. In addition, a luminance change may not be great according to the change of the luminance setting value DBV so that the luminance change may not be shown to the user.

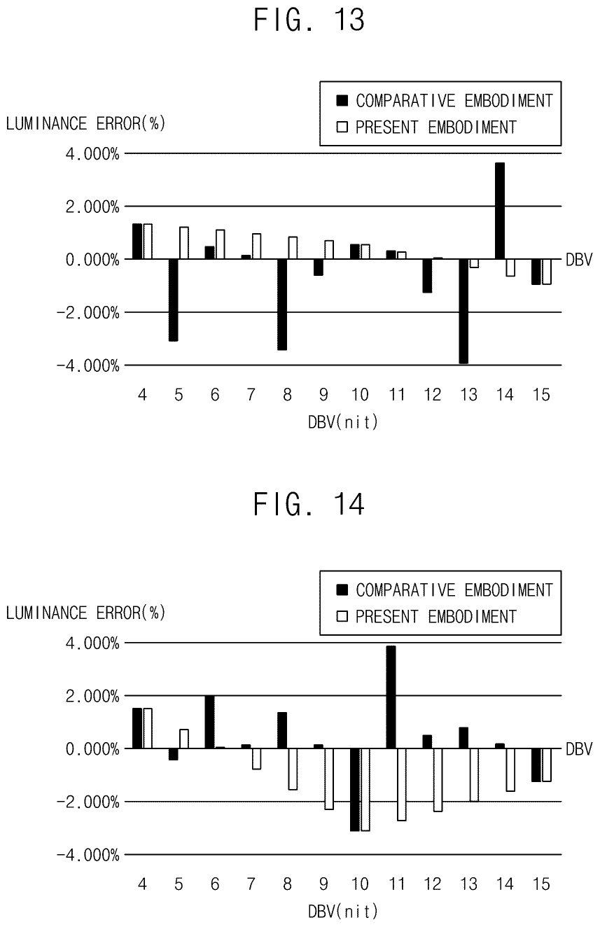

FIG. 12 is a graph illustrating luminance errors according to luminance setting values of the comparative embodiment and the embodiment for the luminance of 0.01 nit. FIG. 13 is a graph illustrating luminance errors according to luminance setting values of the comparative embodiment and the embodiment for the luminance of 0.05 nit. FIG. 14 is a graph illustrating luminance errors according to luminance setting values of the comparative embodiment and the embodiment for the luminance of 0.1 nit.

FIGS. 12 to 14 illustrate the luminance errors so that a case in which a graph of the luminance error shows a horizontal line corresponding to 0% is the most ideal case.

In the comparative embodiment in FIGS. 12 to 14, the luminance errors for the luminance setting value DBV of 4 nit, 10 nit and 15 nit in which the measurement (MTP) is performed may be relatively little but the luminance errors for the luminance setting value DBV in which the measurement (MTP) is not performed may be relatively great.

In an embodiment in FIGS. 12 to 14, the interpolation is performed based on the same luminance instead of the same grayscale value so that the luminance errors for the luminance setting value DBV in which the measurement (MTP) is not performed may be little as well as the luminance errors for the luminance setting value DBV of 4 nit, 10 nit and 15 nit in which the measurement (MTP) is performed.

It can be seen that the luminance errors in an embodiment in FIG. 14 is greater than the luminance errors of the comparative embodiment in FIG. 14, but more important issue is that the luminance change amount is not great according to the change of the luminance setting value DBV. The luminance change amount in the embodiment when changing the luminance setting value DBV is still less than the luminance change amount in the comparative embodiment when changing the luminance setting value DBV.

According to an embodiment, the target luminance LTD for the target luminance setting value TD and the target grayscale value TG may be determined based not on the luminance of the same grayscale value for the adjacent measured luminance setting value MD1 and MD2 but on the closest luminance for the adjacent measured luminance setting value MD1 and MD2 when determining the target luminance LTD.

Thus, when the luminance setting value DBV is changed, the luminance change amount may be reduced so that the display quality of the display panel 100 may be enhanced.

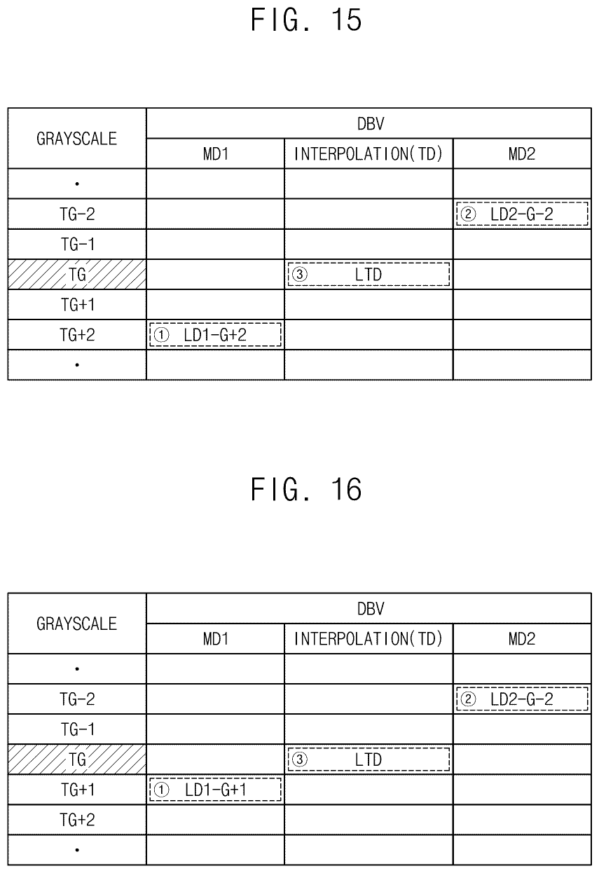

FIG. 15 is a table illustrating a method of gamma control of a gamma controller of a display apparatus according to an embodiment of the invention.

The embodiment of the method of gamma control of a gamma controller of a display apparatus shown in FIG. 15 is substantially the same as the embodiment described above referring to FIGS. 1 to 14 except for the method of the gamma control. Thus, the same reference numerals will be used to refer to the same or like parts as those of the embodiments of FIGS. 1 to 14 and any repetitive detailed description thereof will be omitted.

Referring to FIGS. 1, 2 and 15, in an embodiment, the display panel driver may include the driving controller 200. The driving controller 200 may include the gamma controller 220.

The display panel driver (e.g., the gamma controller 220) may generate the reference luminance L1, L2, . . . , LX corresponding to the luminance setting value DBV.

The display panel driver (the gamma controller 220) determines a target luminance LTD for a target luminance setting value TD and a target grayscale value TG based on a first luminance LD1-G+2 for a first adjacent luminance setting value MD1 and a first grayscale value (e.g. TG+2) and a second luminance LD1-G−2 for a second adjacent luminance setting value MD2 and a second grayscale value (e.g. TG−2).

In an embodiment, the target luminance LTD for the target luminance setting value TD and the target grayscale value TG is determined using the luminances LD1-G+2 and LD2-G−2 of the first grayscale value TG+2 and the second grayscale value TG−2 for the adjacent measured luminance setting values MD1 and MD2 which are closest to the proper luminance instead of using the luminances of the same grayscale value TG for the adjacent measured luminance setting values MD1 and MD2 so that an accuracy of the interpolation may be enhanced.

The first adjacent luminance setting value MD1 may be less than the target luminance setting value TD. Herein, the first grayscale value TG+2 may be equal to or greater than the target grayscale value TG. In an embodiment, for example, the first grayscale value TG+2 may be greater than the target grayscale value TG. In an embodiment, as shown in FIG. 15, the first grayscale value TG+2 is greater than the target grayscale value TG by two.

In addition, the second adjacent luminance setting value MD2 may be greater than the target luminance setting value TD. Herein, the second grayscale value TG−2 may be equal to or less than the target grayscale value TG. In an embodiment, for example, the second grayscale value TG−2 may be less than the target grayscale value TG. In an embodiment, as shown in FIG. 15, the second grayscale value TG−2 is less than the target grayscale value TG by two.

According to an embodiment, the target luminance LTD for the target luminance setting value TD and the target grayscale value TG may be determined based not on the luminance of the same grayscale value for the adjacent measured luminance setting value MD1 and MD2 but on the closest luminance for the adjacent measured luminance setting value MD1 and MD2 when determining the target luminance LTD.

Thus, when the luminance setting value DBV is changed, the luminance change amount may be reduced so that the display quality of the display panel 100 may be enhanced.

FIG. 16 is a table illustrating a method of gamma control of a gamma controller of a display apparatus according to an embodiment of the invention.

The embodiment of the method of gamma control of a gamma controller of a display apparatus shown in FIG. 16 is substantially the same as the embodiments described above referring to FIGS. 1 to 14 except for the method of the gamma control. Thus, the same reference numerals will be used to refer to the same or like parts as those described of the embodiments of FIGS. 1 to 14 and any repetitive detailed description thereof will be omitted.

Referring to FIGS. 1, 2 and 16, in an embodiment, the display panel driver may include the driving controller 200. The driving controller 200 may include the gamma controller 220.

The display panel driver (e.g., the gamma controller 220) may generate the reference luminance L1, L2, . . . , LX corresponding to the luminance setting value DBV.

The display panel driver (the gamma controller 220) determines a target luminance LTD for a target luminance setting value TD and a target grayscale value TG based on a first luminance LD1-G+1 for a first adjacent luminance setting value MD1 and a first grayscale value (e.g. TG+1) and a second luminance LD1-G−2 for a second adjacent luminance setting value MD2 and a second grayscale value (e.g. TG−2).

In the embodiment, the target luminance LTD for the target luminance setting value TD and the target grayscale value TG is determined using the luminances LD1-G+1 and LD2-G−2 of the first grayscale value TG+1 and the second grayscale value TG−2 for the adjacent measured luminance setting values MD1 and MD2 which are closest to the proper luminance instead of using the luminances of the same grayscale value TG for the adjacent measured luminance setting values MD1 and MD2 so that an accuracy of the interpolation may be enhanced.

The first adjacent luminance setting value MD1 may be less than the target luminance setting value TD. Herein, the first grayscale value TG+1 may be equal to or greater than the target grayscale value TG. In an embodiment, for example, the first grayscale value TG+1 may be greater than the target grayscale value TG. In an embodiment, as shown in FIG. 16, the first grayscale value TG+1 is greater than the target grayscale value TG by one.

In addition, the second adjacent luminance setting value MD2 may be greater than the target luminance setting value TD. Herein, the second grayscale value TG−2 may be equal to or less than the target grayscale value TG. In an embodiment, for example, the second grayscale value TG−2 may be less than the target grayscale value TG. In an embodiment, as shown in FIG. 16, the second grayscale value TG−2 is less than the target grayscale value TG by two.

According to an embodiment, the target luminance LTD for the target luminance setting value TD and the target grayscale value TG may be determined based not on the luminance of the same grayscale value for the adjacent measured luminance setting value MD1 and MD2 but on the closest luminance for the adjacent measured luminance setting value MD1 and MD2 when determining the target luminance LTD.

Thus, when the luminance setting value DBV is changed, the luminance change amount may be reduced so that the display quality of the display panel 100 may be enhanced.

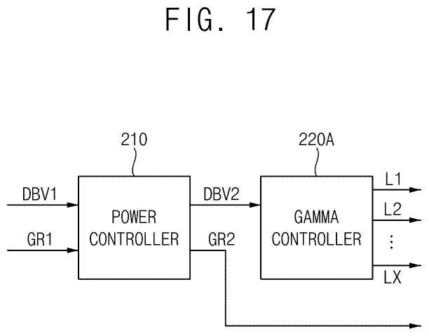

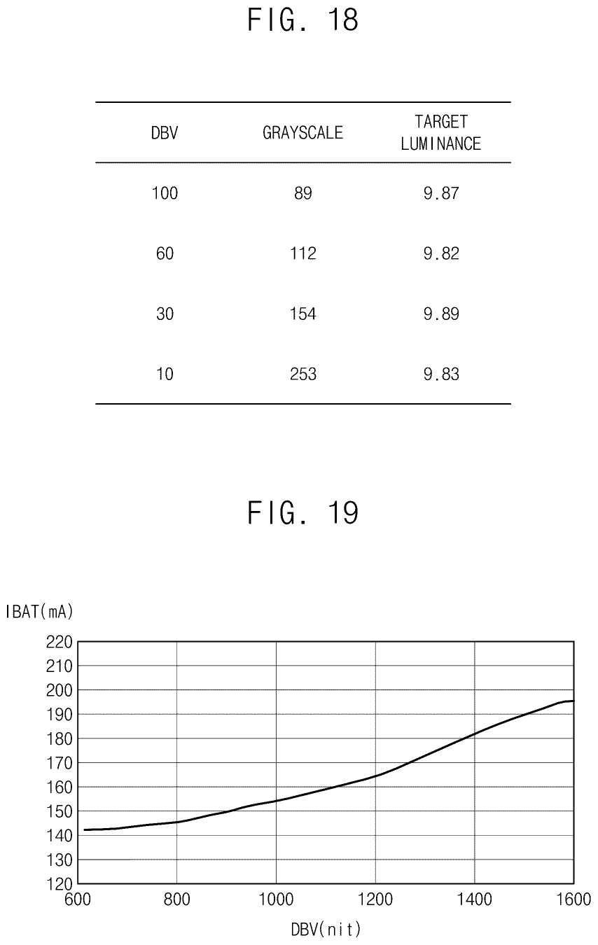

FIG. 17 is a block diagram illustrating a driving controller of a display apparatus according to an embodiment of the invention. FIG. 18 is a table illustrating an operation of a power controller 210 of FIG. 17. FIG. 19 is a graph illustrating an operation of the power controller 210 of FIG. 17.

The embodiment of the driving controller of a display apparatus according to the embodiment is substantially the same as the embodiment described above referring to FIGS. 1 to 14 except for the structure and the operation of the display panel driver. Thus, the same reference numerals will be used to refer to the same or like parts as those of the embodiments of FIGS. 1 to 14 and any repetitive detailed description thereof will be omitted.

Referring to FIGS. 1, 2 and 17 to 19, in an embodiment, the display panel driver may include the driving controller 200. The driving controller 200 may include the power controller 210 and a gamma controller 220A.

The power controller 210 may receive an input luminance setting value DBV1 and an input grayscale value GR1 and output an output luminance setting value DBV2 and an output grayscale value GR2.

In an embodiment, as shown in FIG. 18, even if the luminance setting value DBV is decreased, if the grayscale is increased, substantially the same target luminance (e.g., 9.87, 9.82, 9.89 and 9.83) may be displayed for different luminance setting values DBV.

As shown in FIG. 19, as the luminance setting value DBV decreases, a current consumption IBAT may decrease. Thus, to display the same target luminance, the display panel driver may increase the grayscale value instead of decreasing the luminance setting value DBV.

As such, when the luminance setting value DBV is adjusted to display the same target luminance, a rapid luminance change may be shown to a user.

The display panel driver (e.g., the gamma controller 220A) may generate the reference luminance L1, L2, . . . , LX corresponding to the luminance setting value DBV.

The display panel driver (the gamma controller 220A) determines a target luminance LTD for a target luminance setting value TD and a target grayscale value TG based on a first luminance for a first adjacent luminance setting value MD1 and a first grayscale value and a second luminance for a second adjacent luminance setting value MD2 and a second grayscale value.

In an embodiment, the target luminance LTD for the target luminance setting value TD and the target grayscale value TG is determined using the luminances of the first grayscale value and the second grayscale value for the adjacent measured luminance setting values MD1 and MD2 which are closest to the proper luminance instead of using the luminances of the same grayscale value TG for the adjacent measured luminance setting values MD1 and MD2 so that an accuracy of the interpolation may be enhanced.

According to an embodiment, the target luminance LTD for the target luminance setting value TD and the target grayscale value TG may be determined based not on the luminance of the same grayscale value for the adjacent measured luminance setting value MD1 and MD2 but on the closest luminance for the adjacent measured luminance setting value MD1 and MD2 when determining the target luminance LTD.

Thus, when the luminance setting value DBV is changed, the luminance change amount may be reduced so that the display quality of the display panel 100 may be enhanced.

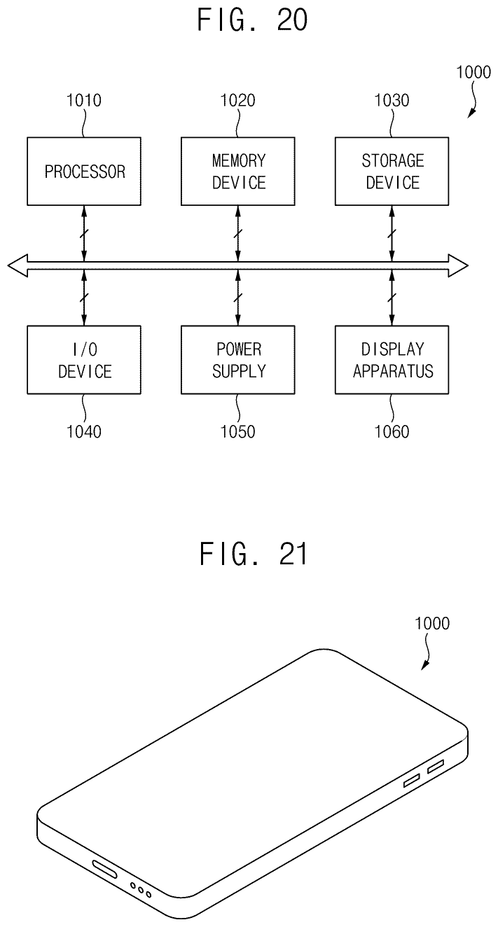

FIG. 20 is a block diagram illustrating an electronic apparatus according to an embodiment of the invention. FIG. 21 is a diagram illustrating an embodiment in which the electronic apparatus of FIG. 20 is implemented as a monitor.

Referring to FIGS. 20 and 21, an embodiment of the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In an embodiment, as illustrated in FIG. 21, the electronic apparatus 1000 may be implemented as a monitor. However, the electronic apparatus 1000 is not limited thereto. For example, the electronic apparatus 1000 may be implemented as a television, a cellular phone, a video phone, a smart pad, a smart watch, a tablet computer, a car navigation system, a laptop, a head mounted display (HMD) device, or the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like. The I/O device 1040 may include an input device such as a keyboard, a keypad, a mouse device, a touch-pad, a touch-screen, and the like and an output device such as a printer, a speaker, or the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

According to embodiments of the display apparatus, the luminance change amount may be reduced when changing the luminance setting value.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display apparatus comprising:
a display panel; and
a display panel driver which drives the display panel,
wherein the display panel driver determines a target luminance for a target luminance setting value and a target grayscale value based on a first luminance for a first adjacent luminance setting value and a first grayscale value and a second luminance for a second adjacent luminance setting value and a second grayscale value, and
wherein at least one selected from the first grayscale value and the second grayscale value is different from the target grayscale value.

2. The display apparatus of claim 1, wherein the first adjacent luminance setting value is less than the target luminance setting value, and
wherein the first grayscale value is equal to or greater than the target grayscale value.

3. The display apparatus of claim 2, wherein the first grayscale value is greater than the target grayscale value.

4. The display apparatus of claim 3, wherein the first grayscale value is greater than the target grayscale value by one.

5. The display apparatus of claim 1, wherein the second adjacent luminance setting value is greater than the target luminance setting value, and
wherein the second grayscale value is equal to or less than the target grayscale value.

6. The display apparatus of claim 5, wherein the second grayscale value is less than the target grayscale value.

7. The display apparatus of claim 6, wherein the second grayscale value is less than the target grayscale value by one.

8. The display apparatus of claim 1, wherein the display panel driver determines a plurality of target luminances for a plurality of target grayscale values based on a plurality of luminances in the first adjacent luminance setting value and a plurality of luminances in the second adjacent luminance setting value.

9. The display apparatus of claim 8, wherein the display panel driver determines an interpolation luminance for an interpolation grayscale value between the target grayscale values using adjacent target luminances of adjacent target grayscale values adjacent to the interpolation grayscale value in the target luminance setting value, and
wherein the adjacent target luminances are luminances in the target luminance setting value.

10. The display apparatus of claim 8, wherein the display panel driver determines an interpolation luminance for an interpolation grayscale value between the target grayscale values in the target luminance setting value based on a luminance in the first adjacent luminance setting value and a luminance in the second adjacent luminance setting value.

11. The display apparatus of claim 1, wherein the display panel driver includes a gamma controller, a gamma reference voltage generator and a data driver,
wherein the gamma controller determines the target luminance for the target luminance setting value and the target grayscale value,
wherein the gamma reference voltage generator generates a gamma reference voltage based on a reference luminance including the target luminance, and
wherein the data driver generates a data voltage based on a grayscale value of input image data and the gamma reference voltage and outputs the data voltage to the display panel.

12. The display apparatus of claim 1, wherein the display panel driver includes a power controller, a gamma controller, a gamma reference voltage generator and a data driver,
wherein the power controller receives an input luminance setting value and an input grayscale value and outputs an output luminance setting value and an output grayscale value,
wherein the gamma controller determines the target luminance for the target luminance setting value and the target grayscale value,
wherein the gamma reference voltage generator generates a gamma reference voltage based on a reference luminance including the target luminance, and
wherein the data driver generates a data voltage based on the output grayscale value and the gamma reference voltage and outputs the data voltage to the display panel.

13. The display apparatus of claim 12, wherein the output luminance setting value is less than the input luminance setting value, and
wherein the output grayscale value is greater than the input grayscale value.

14. A method of gamma control for a display apparatus, the method comprising:
determining a target luminance for a target luminance setting value and a target grayscale value based on a first luminance for a first adjacent luminance setting value and a first grayscale value and a second luminance for a second adjacent luminance setting value and a second grayscale value,
wherein at least one selected from the first grayscale value and the second grayscale value is different from the target grayscale value.

15. The method of claim 14, wherein the first adjacent luminance setting value is less than the target luminance setting value, and
wherein the first grayscale value is greater than the target grayscale value.

16. The method of claim 14, wherein the second adjacent luminance setting value is greater than the target luminance setting value, and
wherein the second grayscale value is less than the target grayscale value.

17. The method of claim 14, wherein a display panel driver of the display apparatus determines a plurality of target luminances for a plurality of target grayscale values based on a plurality of luminances in the first adjacent luminance setting value and a plurality of luminances in the second adjacent luminance setting value.

18. The method of claim 17, wherein the display panel driver determines an interpolation luminance for an interpolation grayscale value between the target grayscale values using adjacent target luminances of adjacent target grayscale values adjacent to the interpolation grayscale value in the target luminance setting value, and
wherein the adjacent target luminances are luminances in the target luminance setting value.

19. The method of claim 17, wherein the display panel driver determines an interpolation luminance for an interpolation grayscale value between the target grayscale values in the target luminance setting value based on a luminance in the first adjacent luminance setting value and a luminance in the second adjacent luminance setting value.
